(19) United States
(12) Patent Application Publication
(10) Pub. No.: US 2023/0225267 A1
(43) Pub. Date: Jul. 20, 2023

(54) Garden Watering Assembly

(71) Applicants: Anthony Osburn, Riverdale, GA (US); Trevor Greenhill, Riverdale, GA (US)

(72) Inventors: Anthony Osburn, Riverdale, GA (US); Trevor Greenhill, Riverdale, GA (US)

(21) Appl. No.: 17/580,212

(22) Filed: Jan. 20, 2022

(51) Int. Cl. A01G 25/16; H04Q 9/00; H02S 40/38

(52) U.S. Cl. CPC A01G 25/167; H04Q 9/00; H02S 40/38; H04Q 2209/10; H04Q 2209/30

(57) ABSTRACT

A garden watering assembly includes a plurality of sensing units and each of the sensing units has a probe which is insertable into soil in a garden to determine moisture content of the soil in the garden. The sensing units broadcast a sensing signal comprising moisture content of the soil in the garden. A controller module broadcasts an irrigation signal when the controller module receives a sensing signal from any of the sensing units which communicates a moisture level that is below the pre-determined moisture threshold. A pump unit is in remote communication with the controller module and the pump unit irrigates the soil in the garden when the controller module broadcasts the irrigation signal.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to watering devices and more particularly pertains to a new watering device for automatically irrigating a garden. The device includes a plurality of sensing units for sensing moisture content of soil. The device includes a controller module that is in wireless communication with each of the sensing units and a pump that is fluidly coupled to an irrigation system. The pump is in wireless communication with the controller module and the pump is turned on when the moisture content of the soil falls below a predetermined threshold.

### (2) Description of Related Art including information disclosed under 37 CFR 1.97 and 1.98

The prior art relates to watering devices including a watering plant pot that includes a porous sensing element and a fluid reservoir integrated into a plant pot. The prior art discloses an above ground irrigation device. The prior art discloses a below ground irrigation device. The prior art discloses an automated irrigation device for automatically watering a flower pot. The prior art discloses an automated irrigation system that includes remote sensors, a control system and a multiple channel conduit for automatically irrigating a crop.

### BRIEF SUMMARY OF THE INVENTION

An embodiment of the disclosure meets the needs presented above by generally comprising a plurality of sensing units and each of the sensing units has a probe which is insertable into soil in a garden to determine moisture content of the soil in the garden. The sensing units broadcast a sensing signal comprising moisture content of the soil in the garden. A controller module broadcasts an irrigation signal when the controller module receives a sensing signal from any of the sensing units which communicates a moisture level that is below the pre-determined moisture threshold. A pump unit is in remote communication with the controller module and the pump unit irrigates the soil in the garden when the controller module broadcasts the irrigation signal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a garden watering assembly according to an embodiment of the disclosure.

FIG. 2 is a front phantom view of a pump unit of an embodiment of the disclosure.

FIG. 3 is a front phantom view of a controller module of an embodiment of the disclosure.

FIG. 4 is a front phantom view of sensing unit of an embodiment of the disclosure.

FIG. 5 is a perspective in-use view of an embodiment of the disclosure.

FIG. 6 is a schematic view of an embodiment of the disclosure.

### DETAILED DESCRIPTION OF THE INVENTION

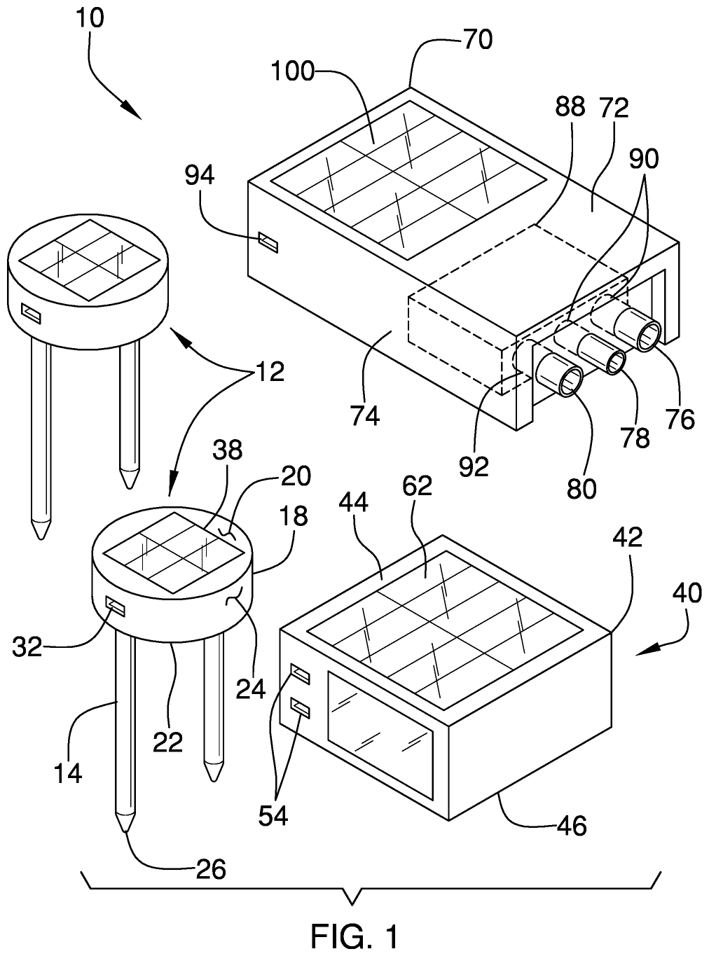

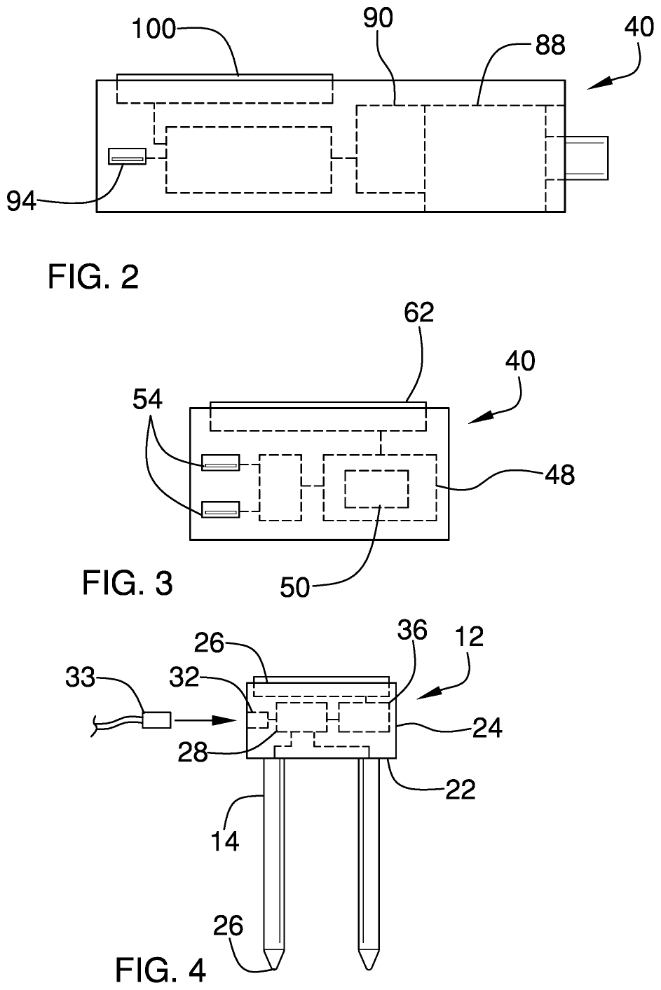

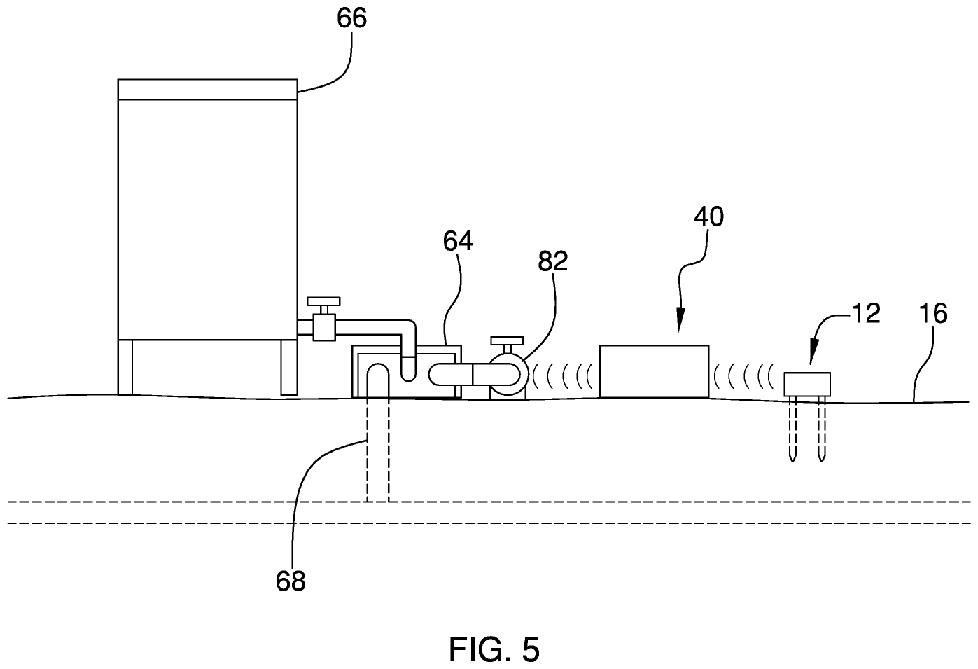

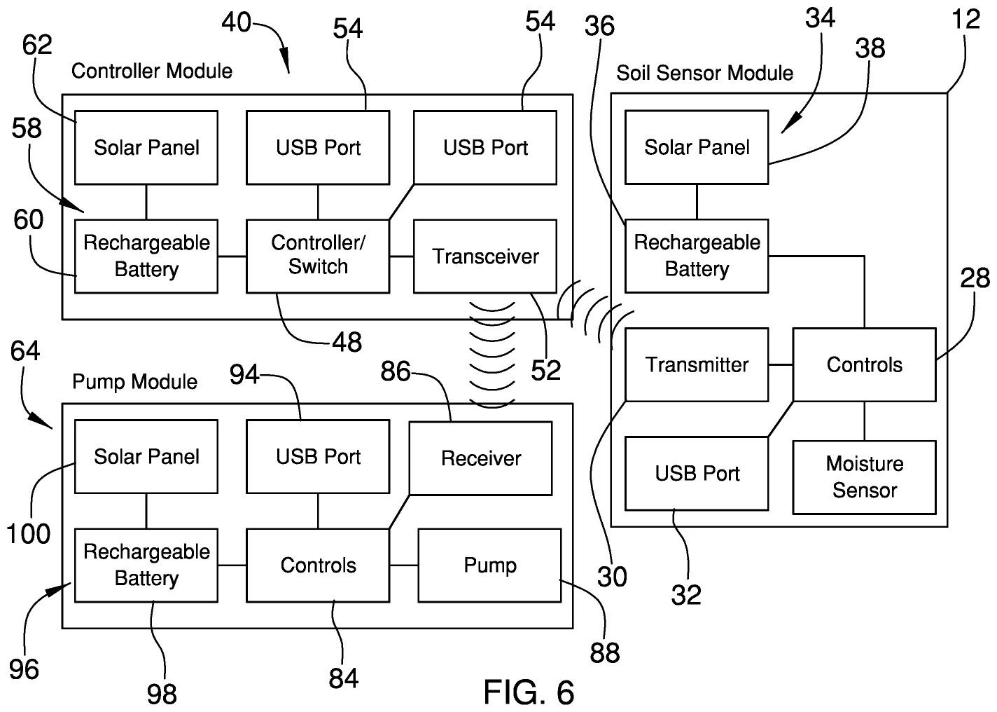

With reference now to the drawings, and in particular to FIGS. 1 through 6 thereof, a new watering device embodying the principles and concepts of an embodiment of the disclosure and generally designated by the reference numeral 10 will be described.

As best illustrated in FIGS. 1 through 6, the garden watering assembly 10 generally comprises a plurality of sensing units 12 that each has a probe 14 which is insertable into soil 16 in a garden. In this way the probe 14 in each of the sensing units 12 is in fluid communication with the soil 16 in the garden thereby facilitating each of the sensing units 12 to determine moisture content of the soil 16 in the garden. Each of the sensing units 12 broadcasts a sensing signal comprising moisture content of the soil 16 in the garden. The garden may be a vegetable garden, a flower garden or any other type of garden involving purpose grown plants.

Each of the sensing units 12 comprises a puck 18 that has a top surface 20, a bottom surface 22 and a peripheral surface 24 extending between the top surface 20 and the bottom surface 22. The probe 14 extends downwardly from the bottom surface 22 and the probe 14 has a distal end 26 with respect to the bottom surface 22. The distal end 26 tapers to a point to facilitate the distal end 26 to penetrate the soil 16 in the garden. Additionally, the probe 14 is comprised of an electrical conductive material to sense electrical conductivity of moisture in the soil 16 in the garden.

Each of the sensing units 12 includes a sensing control circuit 28 that is integrated into the puck 18 and the sensing control circuit 28 is electrically coupled to the probe 14. Each of the sensing units 12 includes a transmitter 30 is integrated into the puck 18. The transmitter 30 is electrically coupled to the sensing control circuit 28 and the transmitter 30 broadcasts the sensing signal. Furthermore, the transmitter 30 in each of the sensing units 12 may comprise a radio frequency transmitter 30 or the like.

Each of the sensing units 12 includes a sensing data port 32 that is recessed into the peripheral surface 24 of the puck 18 which can insertably receive a data cord 33. The sensing data port 32 is electrically coupled to the sensing control circuit 28 to facilitate operational parameters to be downloaded into the sensing control circuit 28. The sensing data port 32 may comprise a universal serial bus port or other similar type of data port and the data cord 33 may be universal serial bus cord or other similar type of data cord. Additionally, the data cord 33 may receive data from a personal computer or other similar type of electronic device that can download data.

Each of the sensing units 12 includes a sensing power supply 34 which is integrated into the puck 18, and the sensing power supply 34 is electrically coupled to the sensing control circuit 28. The sensing power supply 34 comprises a rechargeable battery 36 which is positioned within the puck 18, and the rechargeable battery 36 is electrically coupled to the sensing control circuit 28. The sensing power supply 34 includes a solar panel 38 that is coupled to the top surface 20 of the puck 18 such that the solar panel 38 is exposed to sunlight. The solar panel 38 is electrically coupled to the rechargeable battery 36 for charging the rechargeable battery 36.

A controller module 40 is provided and the controller module 40 is in remote communication with each of the sensing units 12. The controller module 40 stores a database comprising a pre-determined moisture threshold of soil 16 in the garden. The controller module 40 broadcasts an irrigation signal when the controller module 40 receives the sensing signal from any of the sensing units 12 which communicates a moisture level that is below the pre-determined moisture threshold. Furthermore, the controller module 40 broadcasts a stop irrigation signal when the controller module 40 receives the sensing signal from any of the sensing units 12 which communicates a moisture level that is above the pre-determined moisture threshold. In this way the moisture content of the soil 16 in the garden is continuously and automatically monitored.

The controller module 40 comprises a controller housing 42 that has a top wall 44 and an outer wall 46. A controller control circuit 48 is integrated into the controller housing 42 and the controller control circuit 48 includes an electronic memory 50. The electronic memory 50 stores a database comprising the pre-determined moisture content of the soil 16 in the garden. The pre-determined moisture content may be determined based on the type of soil 16 in the garden, the types of plants that will be grown in the garden, the geographic location of the garden and any other determining factors.

The controller module 40 includes a transceiver 52 that is integrated into the controller housing 42 and the transceiver 52 is electrically coupled to the controller control circuit 48. The transceiver 52 is in wireless communication with the transmitter 30 in each of the sensing units 12 such that the transceiver 52 receives the sensing signal from the transmitter 30 in each of the sensing units 12. Furthermore, the transceiver 52 broadcasts the irrigation signal when the controller control circuit 48 determines that the moisture level communicated in the sensing signal is below the pre-determined moisture content of the soil 16 in the garden. The transceiver 52 broadcasts the stop irrigation signal when the controller control circuit 48 determines that the moisture level communicated in the sensing signal is above the pre-determined moisture content of the soil 16 in the garden. Additionally, the transceiver 52 may comprise a radio frequency transceiver or the like.

The controller module 40 includes a plurality of control data ports 54 is provided and each of the control data ports 54 is recessed into the outer wall 46 of the controller housing 42. Each of the control data ports 54 insertably receives a data cord 33 for downloading data into the electronic memory 50. Each of the control data ports 54 may comprise a universal serial bus port or the like. The controller module 40 includes a controller power supply 58 that is integrated into the controller housing 42 and the controller power supply 58 is electrically coupled to the controller control circuit 48.

The controller power supply 58 comprises a rechargeable battery 60 which is positioned within the controller housing 42. The rechargeable battery 60 in the controller housing 42 is electrically coupled to the controller control circuit 48. The controller power supply 58 comprises a solar panel 62 that is coupled to the top wall 44 of the controller housing 42. The solar panel 62 on the controller housing 42 is electrically coupled to the rechargeable battery 60 in the controller housing 42 for charging the rechargeable battery 60 in the controller housing 42.

A pump unit 64 is provided and the pump unit 64 is fluidly coupled to a water source 66, such as a water tank, a garden hose, or other water source that would commonly be available at a residence. The pump unit 64 is fluidly coupled to an irrigation system 68 that is employed for irrigating the soil 16 in the garden. Additionally, the pump unit 64 is in remote communication with the controller module 40 such that the pump unit 64 receives the irrigation signal from the controller module 40. The pump unit 64 is turned on when the pump unit 64 receives the irrigation signal and the pump unit 64 pumps water from the water source 66 into the irrigation system 68. In this way the pump unit 64 irrigates the soil 16 in the garden.

The pump unit 64 comprises a pump housing 70 that has an upper wall 72 and an outside wall 74, and the outside wall 74 has a water inlet 76 extending into an interior of the pump housing 70. The outside wall 74 has a nutrient inlet 78 extending into the interior of the pump housing 70 and the outside wall 74 has an irrigation outlet 80 extending into the interior of the pump housing 70. The water inlet 76 is fluidly coupled to the water source 66, the nutrient inlet 78 is fluidly coupled to a nutrient source 82 and the irrigation outlet 80 is fluidly coupled to an input of the irrigation system 68. The nutrient source 82 may comprise a fluid tank filled with liquid fertilizer or other similar type of nutrient source.

The pump unit 64 includes a pump control circuit 84 that is positioned within the pump housing 70, and the pump control circuit 84 receives an on input and an off input. The pump unit 64 includes a receiver 86 that is integrated into the pump housing 70 and the receiver 86 is electrically coupled to the pump control circuit 84. The receiver 86 is in wireless communication with the transceiver 52, and the receiver 86 receives the irrigation signal from the transceiver 52 and the stop irrigation signal from the transceiver 52. The pump control circuit 84 receives the on input when the receiver 86 receives irrigation signal. Conversely, the pump control circuit 84 receives the off input when the receiver 86 receives the stop irrigation signal. The receiver 86 may comprise a radio frequency receiver or the like and the receiver 86 may have an operational frequency that is discretely assigned to the transceiver 52 such that the receiver 86 will not communicate with any wireless device aside from the transceiver 52.

The pump unit 64 includes a pump 88 that is positioned within the pump housing 70, and the pump 88 has an inlet 90 and an exhaust 92. The inlet 90 is fluidly coupled to each of the water inlet 76 and the nutrient inlet 78, and the exhaust 92 is fluidly coupled to the irrigation outlet 80. The pump 88 urges water from the water source 66 and nutrients from the nutrient source 82 outwardly through the exhaust 92 when the pump 88 is turned on. The pump 88 is electrically coupled to the pump control circuit 84 and the pump 88 is turned on when the pump control circuit 84 receives the on input. Conversely, the pump 88 is turned off when the pump control circuit 84 receives the off input. The pump 88 may comprise an electric fluid pump or other similar device.

The pump unit 64 includes a pump data port 94 that is recessed into the outside wall 74 of the pump housing 70 to insertably receive a data cord 33. The pump data port 94 is electrically coupled to the pump control circuit 84 for downloading data into the pump control circuit 84. The pump unit 64 includes a pump power supply 96 that is integrated into the pump housing 70 and the pump power supply 96 is electrically coupled to the pump control circuit 84. The pump power supply 96 comprises a rechargeable battery 98 that is positioned within the pump housing 70. The rechargeable battery 98 in the pump housing 70 is electrically coupled to the pump control circuit 84. The pump power supply 96 includes solar panel 100 that is coupled to the upper wall 72 of the pump housing 70. The solar panel 100 on the pump housing 70 is electrically coupled to the rechargeable battery 98 in the pump housing 70 for charging the rechargeable battery 98 in the pump housing 70.

In use, the pre-determined moisture content threshold is downloaded into the controller module 40 via the control data ports 54. Each of the sensing units 12 is positioned at a strategic location in the garden such that the probe 14 on each of the sensing units 12 penetrates the soil 16. The pump unit 64 is turned on when the sensing units 12 senses that the moisture content of the soil 16 falls below the pre-determined moisture content, and the pump is turned off when the sensing units 12 senses the moisture content of the soil 16 rises above the pre-determined moisture content. In this way the pump 88 automatically irrigates the soil 16 such that the soil 16 is continuously maintained at the pre-determined moisture content. Additionally, the sensing units 12 can be repositioned at any time in the soil 16 for monitoring different areas of the garden.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A garden watering assembly for monitoring soil moisture levels and selectively irrigating a garden, said assembly comprising:
a plurality of sensing units, each of said sensing units having a probe being insertable into soil in a garden wherein said probe in each of said sensing units is configured to be in fluid communication with the soil in the garden thereby facilitating each of said sensing units to determine moisture content of the soil in the garden, said sensing units broadcasting a sensing signal comprising a moisture content of the soil in the garden;
a controller module being in remote communication with each of said sensing units, said controller module storing a database comprising a pre-determined moisture threshold of soil in the garden, said controller module broadcasting an irrigation signal when said controller module receives said sensing signal from any of said sensing units which communicates a moisture level that is below said pre-determined moisture threshold, said controller module broadcasting a stop irrigation signal when said controller module receives said sensing signal from any of said sensing units which communicates a moisture level that is above said pre-determined moisture threshold; and
a pump unit being fluidly coupled to a water source, said pump unit being fluidly coupled to an irrigation system, said pump unit being in remote communication with said controller module such that said pump unit receives said irrigation signal from said controller module, said pump unit being turned on when said pump unit receives said irrigation signal, said pump unit pumping water from the water source into the irrigation system wherein said pump unit is configured to irrigate the soil in the garden.

2. The assembly according to claim 1, wherein each of said sensing units comprises a puck having a top surface, a bottom surface and a peripheral surface extending between said top surface and said bottom surface, said probe extending downwardly from said bottom surface, said probe having a distal end with respect to said bottom surface, said distal end tapering to a point wherein said distal end is configured to penetrate the soil in the garden, said probe being comprised of an electrical conductive material wherein said probe is configured to sense electrical conductivity of moisture in the soil in the garden.

3. The assembly according to claim 2, wherein each of said sensing units includes:
a sensing control circuit being integrated into said puck, said sensing control circuit being electrically coupled to said probe; and
a transmitter being integrated into said puck, said transmitter being electrically coupled to said sensing control circuit, said transmitter broadcasting said sensing signal.

4. The assembly according to claim 3, wherein each of said sensing units includes:
a sensing data port being recessed into said peripheral surface of said puck wherein said sensing data port is configured to insertably receive a data cord, said sensing data port being electrically coupled to said sensing control circuit wherein said sensing data port is configured to facilitate operational parameters to be downloaded into said sensing control circuit; and
a sensing power supply being integrated into said puck, said sensing power supply being electrically coupled to said sensing control circuit, said sensing power supply comprising:
a rechargeable battery being positioned within said puck, said rechargeable battery being electrically coupled to said sensing control circuit; and
a solar panel being coupled to said top surface of said puck wherein said solar panel is configured to be exposed to sunlight, said solar panel being electrically coupled to said rechargeable battery for charging said rechargeable battery.

5. The assembly according to claim 3, wherein said controller module comprising:
a controller housing having a top wall and an outer wall;
a controller control circuit being integrated into said controller housing, said controller control circuit including an electronic memory storing a database comprising a pre-determined moisture content of the soil in the garden; and
a transceiver being integrated into said controller housing, said transceiver being electrically coupled to said controller control circuit, said transceiver being in wireless communication with said transmitter in each of said sensing units such that said transceiver receives said sensing signal from said transmitter in each of said sensing units, said transceiver broadcasting said irrigation signal when said controller control circuit determines that said moisture level communicated in said sensing signal is below said pre-determined moisture content of the soil in the garden, said transceiver broadcasting said stop irrigation signal when said controller control circuit determines that said moisture level communicated in said sensing signal is above said pre-determined moisture content of the soil in the garden.

6. The assembly according to claim 5, wherein said controller module includes:
a plurality of control data ports, each of said control data ports being recessed into said outer wall of said controller housing wherein each of said control data ports is configured to insertably receive a data cord for downloading data into said electronic memory; and
a controller power supply being integrated into said controller housing, said controller power supply being electrically coupled to said controller control circuit, said controller power supply comprising:
a rechargeable battery being positioned within said controller housing, said rechargeable battery in said controller housing being electrically coupled to said controller control circuit; and
a solar panel being coupled to said top wall of said controller housing, said solar panel on said controller housing being electrically coupled to said rechargeable battery in said controller housing for charging said rechargeable battery in said controller housing.

7. The assembly according to claim 1, wherein said pump unit comprises a pump housing having an upper wall and an outside wall, said outside wall having a water inlet extending into an interior of said pump housing, said outside wall having a nutrient inlet extending into said interior of said pump housing, said outside wall having an irrigation outlet extending into said interior of said pump housing, said water inlet being fluidly coupled to the water source, said nutrient inlet being fluidly coupled to a nutrient source, said irrigation outlet being fluidly coupled to an input of the irrigation system.

8. The assembly according to claim 7, wherein:
said control unit includes a transceiver, said transceiver broadcasting an irrigation signal and a stop irrigation signal; and
said pump unit comprises:
a pump control circuit being positioned within said pump housing, said pump control circuit receiving an on input and an off input; and
a receiver being integrated into said pump housing, said receiver being electrically coupled to said pump control circuit, said receiver being in wireless communication with said transceiver, said receiver receiving said irrigation signal from said transceiver and said stop irrigation signal from said transceiver, said pump control circuit receiving said on input when said receiver receives irrigation signal, said pump control circuit receiving said off input when said receiver receives said stop irrigation signal.

9. The assembly according to claim 8, wherein said pump unit includes a pump being positioned within said pump housing, said pump having an inlet and an exhaust, said inlet being fluidly coupled to each of said water inlet and said nutrient inlet, said exhaust being fluidly coupled to said irrigation outlet, said pump urging water from the water reservoir and nutrients from the nutrient source outwardly through said exhaust when said pump is turned on, said pump being electrically coupled to said pump control circuit, said pump being turned on when said pump control circuit receives said on input, said pump being turned off when said pump control circuit receives said off input.

10. The assembly according to claim 8, wherein said pump unit includes:
a pump data port being recessed into said outside wall of said pump housing wherein said pump data port is configured to insertably receive a data cord, said pump data port being electrically coupled to said pump control circuit for downloading data into said pump control circuit; and
a pump power supply being integrated into said pump housing, said pump power supply being electrically coupled to said pump control circuit, said pump power supply comprising:
a rechargeable battery being positioned within said pump housing, said rechargeable battery in said pump housing being electrically coupled to said pump control circuit; and
a solar panel being coupled to said upper wall of said pump housing, said solar panel on said pump housing being electrically coupled to said rechargeable battery in said pump housing for charging said rechargeable battery in said pump housing.

11. A garden watering assembly for monitoring soil moisture levels and selectively irrigating a garden, said assembly comprising:
a plurality of sensing units, each of said sensing units having a probe being insertable into soil in a garden wherein said probe in each of said sensing units is configured to be in fluid communication with the soil in the garden thereby facilitating each of said sensing units to determine moisture content of the soil in the garden, said sensing units broadcasting a sensing signal comprising a moisture content of the soil in the garden, each of said sensing units comprising:
a puck having a top surface, a bottom surface and a peripheral surface extending between said top surface and said bottom surface, said probe extending downwardly from said bottom surface, said probe having a distal end with respect to said bottom surface, said distal end tapering to a point wherein said distal end is configured to penetrate the soil in the garden, said probe being comprised of an electrical conductive material wherein said probe is configured to sense electrical conductivity of moisture in the soil in the garden;
a sensing control circuit being integrated into said puck, said sensing control circuit being electrically coupled to said probe;
a transmitter being integrated into said puck, said transmitter being electrically coupled to said sensing control circuit, said transmitter broadcasting said sensing signal;
a sensing data port being recessed into said peripheral surface of said puck wherein said sensing data port is configured to insertably receive a data cord, said sensing data port being electrically coupled to said sensing control circuit wherein said sensing data port is configured to facilitate operational parameters to be downloaded into said sensing control circuit; and
a sensing power supply being integrated into said puck, said sensing power supply being electrically coupled to said sensing control circuit, said sensing power supply comprising:
a rechargeable battery being positioned within said puck, said rechargeable battery being electrically coupled to said sensing control circuit; and
a solar panel being coupled to said top surface of said puck wherein said solar panel is configured to be exposed to sunlight, said solar panel being electrically coupled to said rechargeable battery for charging said rechargeable battery;
a controller module being in remote communication with each of said sensing units, said controller module storing a database comprising a pre-determined moisture threshold of soil in the garden, said controller module broadcasting an irrigation signal when said controller module receives said sensing signal from any of said sensing units which communicates a moisture level that is below said pre-determined moisture threshold, said controller module broadcasting a stop irrigation signal when said controller module receives said sensing signal from any of said sensing units which communicates a moisture level that is above said pre-determined moisture threshold, said controller module comprising:
a controller housing having a top wall and an outer wall;
a controller control circuit being integrated into said controller housing, said controller control circuit including an electronic memory storing a database comprising a pre-determined moisture content of the soil in the garden;
a transceiver being integrated into said controller housing, said transceiver being electrically coupled to said controller control circuit, said transceiver being in wireless communication with said transmitter in each of said sensing units such that said transceiver receives said sensing signal from said transmitter in each of said sensing units, said transceiver broadcasting said irrigation signal when said controller control circuit determines that said moisture level communicated in said sensing signal is below said pre-determined moisture content of the soil in the garden, said transceiver broadcasting said stop irrigation signal when said controller control circuit determines that said moisture level communicated in said sensing signal is above said pre-determined moisture content of the soil in the garden;
a plurality of control data ports, each of said control data ports being recessed into said outer wall of said controller housing wherein each of said control data ports is configured to insertably receive a data cord for downloading data into said electronic memory; and
a controller power supply being integrated into said controller housing, said controller power supply being electrically coupled to said controller control circuit, said controller power supply comprising:
a rechargeable battery being positioned within said controller housing, said rechargeable battery in said controller housing being electrically coupled to said controller control circuit; and
a solar panel being coupled to said top wall of said controller housing, said solar panel on said controller housing being electrically coupled to said rechargeable battery in said controller housing for charging said rechargeable battery in said controller housing; and
a pump unit being fluidly coupled to a water source, said pump unit being fluidly coupled to an irrigation system, said pump unit being in remote communication with said controller module such that said pump unit receives said irrigation signal from said controller module, said pump unit being turned on when said pump unit receives said irrigation signal, said pump unit pumping water from the water source into the irrigation system wherein said pump unit is configured to irrigate the soil in the garden, said pump unit comprising:
a pump housing having an upper wall and an outside wall, said outside wall having a water inlet extending into an interior of said pump housing, said outside wall having a nutrient inlet extending into said interior of said pump housing, said outside wall having an irrigation outlet extending into said interior of said pump housing, said water inlet being fluidly coupled to the water source, said nutrient inlet being fluidly coupled to a nutrient source, said irrigation outlet being fluidly coupled to an input of the irrigation system;
a pump control circuit being positioned within said pump housing, said pump control circuit receiving an on input and an off input;
a receiver being integrated into said pump housing, said receiver being electrically coupled to said pump control circuit, said receiver being in wireless communication with said transceiver, said receiver receiving said irrigation signal from said transceiver and said stop irrigation signal from said transceiver, said pump control circuit receiving said on input when said receiver receives irrigation signal, said pump control circuit receiving said off input when said receiver receives said stop irrigation signal;
a pump being positioned within said pump housing, said pump having an inlet and an exhaust, said inlet being fluidly coupled to each of said water inlet and said nutrient inlet, said exhaust being fluidly coupled to said irrigation outlet, said pump urging water from the water reservoir and nutrients from the nutrient source outwardly through said exhaust when said pump is turned on, said pump being electrically coupled to said pump control circuit, said pump being turned on when said pump control circuit receives said on input, said pump being turned off when said pump control circuit receives said off input;
a pump data port being recessed into said outside wall of said pump housing wherein said pump data port is configured to insertably receive a data cord, said pump data port being electrically coupled to said pump control circuit for downloading data into said pump control circuit; and
a pump power supply being integrated into said pump housing, said pump power supply being electrically coupled to said pump control circuit, said pump power supply comprising:
a rechargeable battery being positioned within said pump housing, said rechargeable battery in said pump housing being electrically coupled to said pump control circuit; and
a solar panel being coupled to said upper wall of said pump housing, said solar panel on said pump housing being electrically coupled to said rechargeable battery in said pump housing for charging said rechargeable battery in said pump housing.
